(19) United States
(12) Patent Application Publication
(10) Pub. No.: US 2010/0280869 A1
(43) Pub. Date: Nov. 4, 2010

(54) System for acquiring building material and completing a building improvement project

(76) Inventor: James A. Nielsen, Scottsdale, AZ (US)

Correspondence Address: TOD R NISSLE, PO BOX 55630, PHOENIX, AZ, 85078, US

(21) Appl. No.: 12/803,690

(22) Filed: Jul. 2, 2010

Related U.S. Application Data
(63) Continuation-in-part of application No. 10/072,552, filed on Feb. 7, 2002, now abandoned.

(51) Int. Cl. G06Q 10/00; G06Q 40/00

(52) U.S. Cl. 705/8

(57) ABSTRACT

A system is provided to acquire building supplies and use the building supplies in a renovation project. The system includes a transaction control system, a delivery confirmation apparatus to confirm delivery of building supplies, and the acquisition by a lender of first lien rights and vendor lien rights as a mechanism to sell securitized bonds to fund lending for a building renovation project.

This is a continuation-in-part of application Ser. No. 10/072,552, filed Feb. 7, 2002.

This invention relates to construction.

More particularly, the invention relates to securing building material and undertaking the renovation of a building.

The owners, or even the lessees, of a building often are hard pressed to carry out a renovation of the building.

Accordingly, it would be highly desirable to provide an improved system to facilitate the renovation of an existing building structure.

Therefore, it is a principal object of the instant invention to provide an improved system to renovate a building structure.

This and other, further and more specific objects and advantages of the invention will be apparent to those skilled in the art from the following detailed description thereof, taken in conjunction with the drawings, in which:

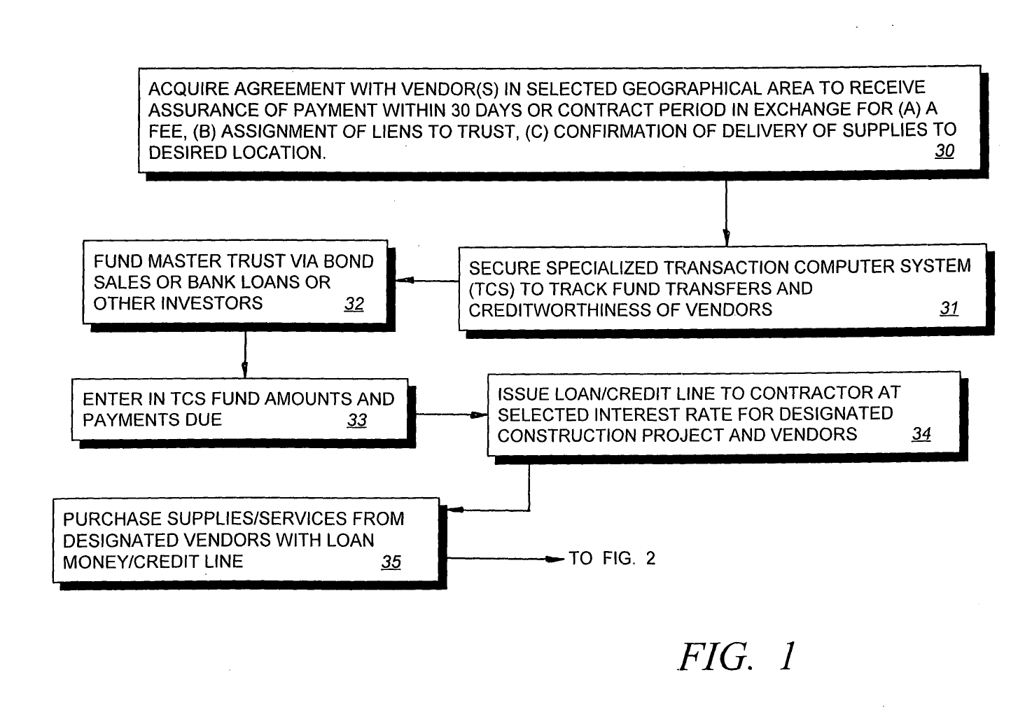

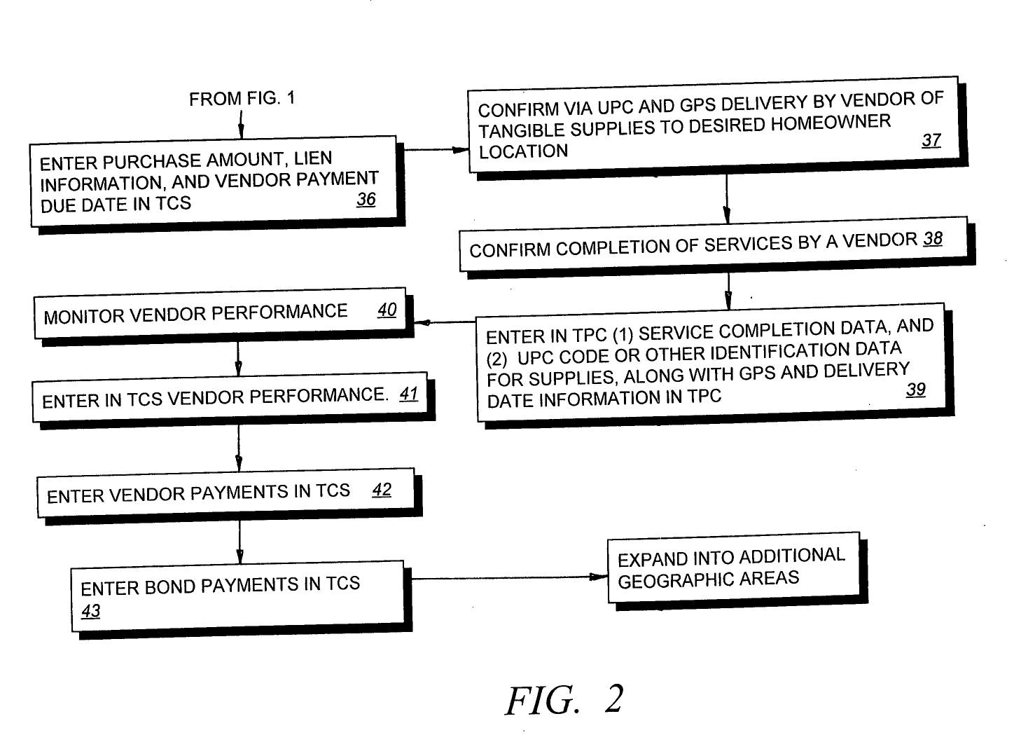

FIG. 1 is a block flow diagram illustrating a renovation system in accordance with the invention;

FIG. 2 is a continuation of the block flow diagram of FIG. 1 further illustrating a renovation system in accordance with the invention;

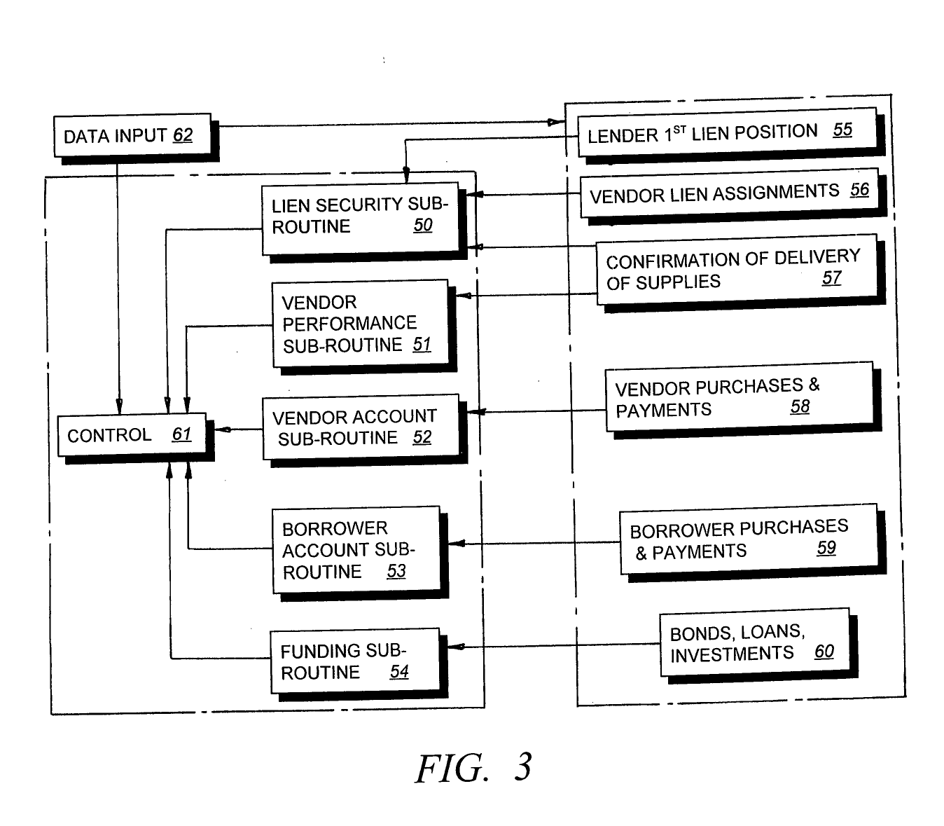

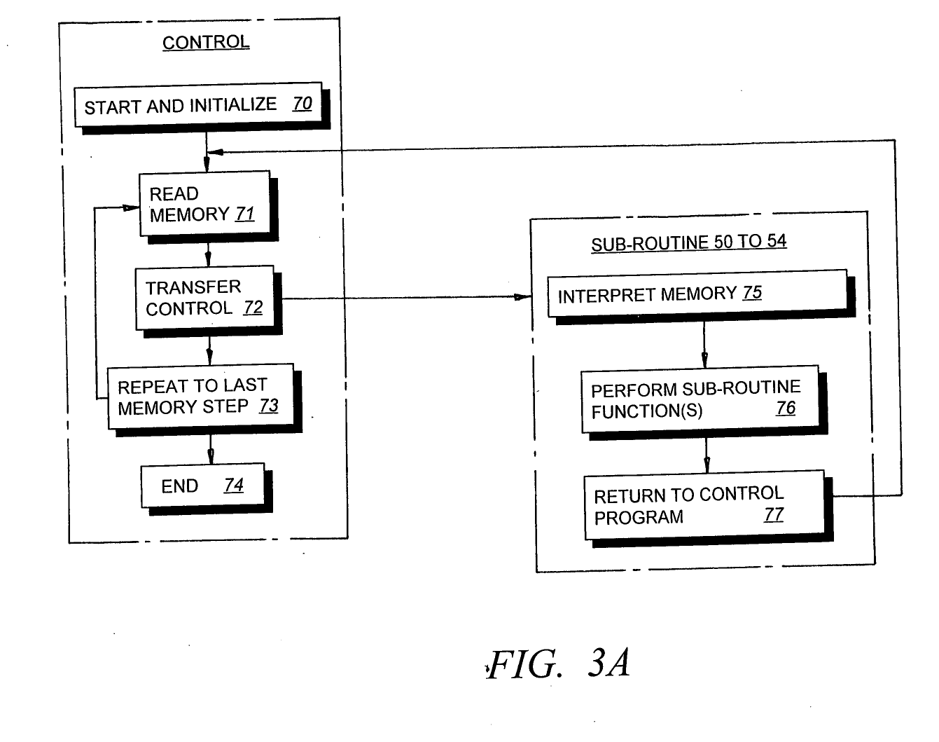

FIG. 3 is a block diagram illustrating a transaction control system utilized in the renovation system of FIGS. 1 and 2;

FIG. 3A is a block flow diagram illustrating a typical logic function utilized by the transaction control program of FIG. 3:

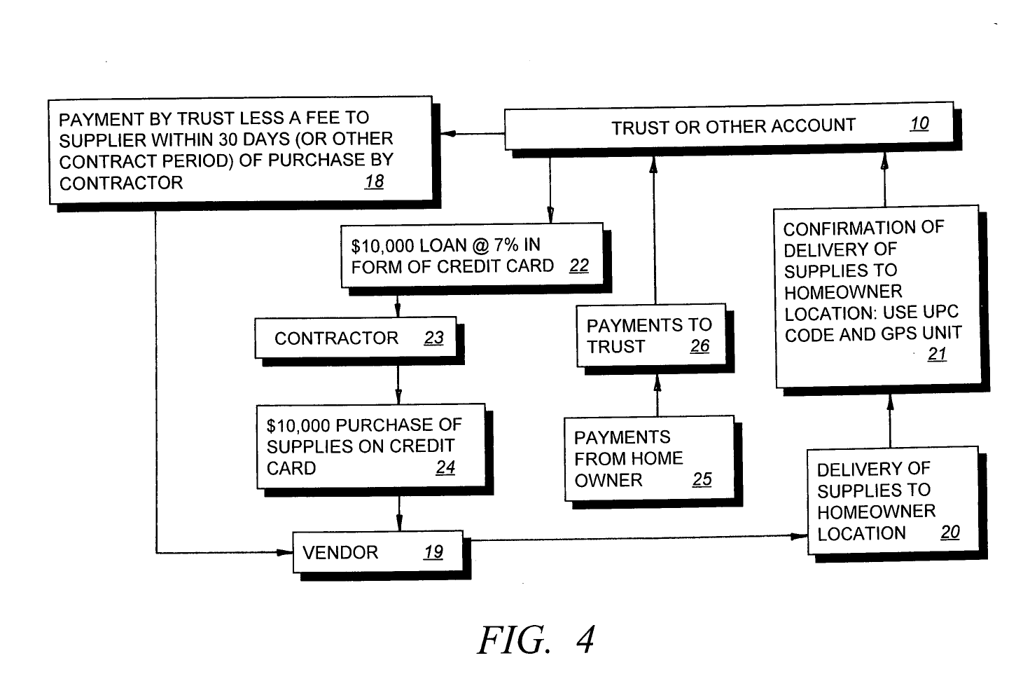

FIG. 4 is a block flow diagram illustrating a typical transaction system in accordance with one embodiment of the invention;

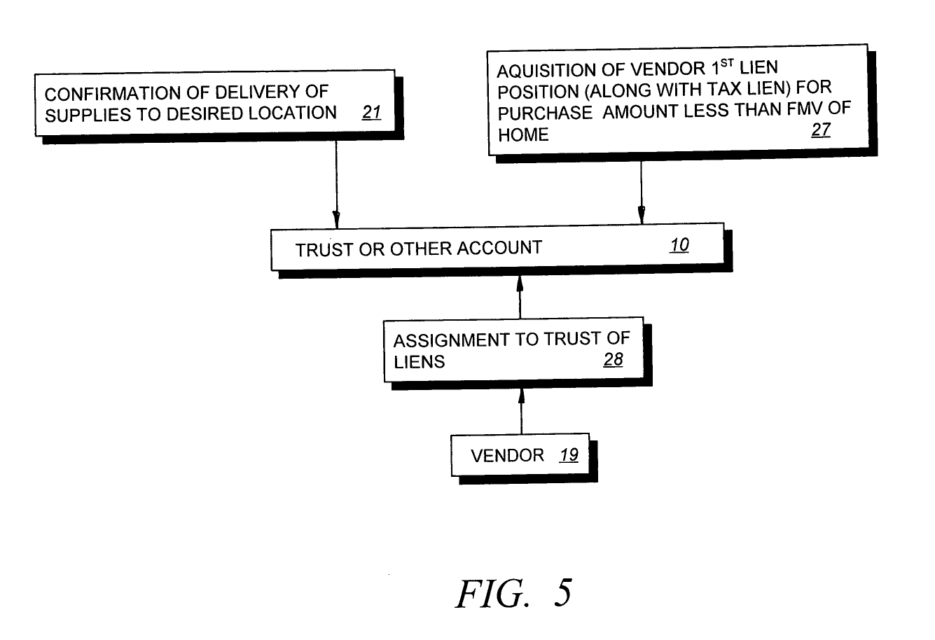

FIG. 5 is a block flow diagram illustrating acquisition of lien security interests in accordance with one embodiment of the invention; and,

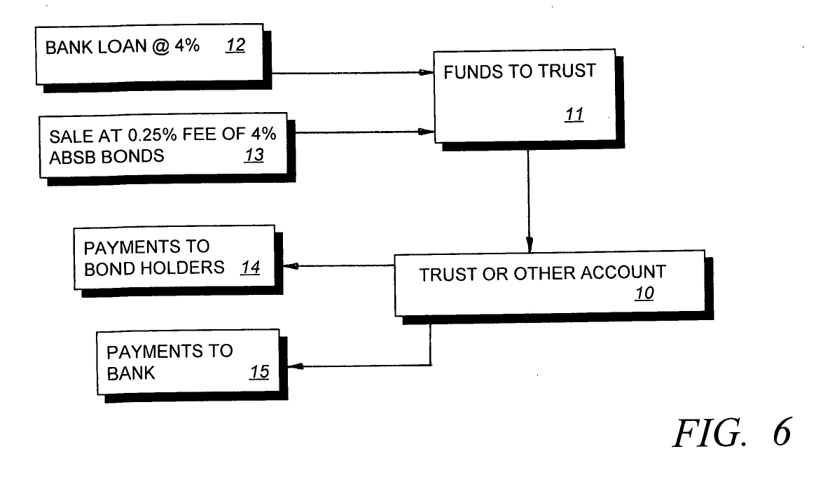

FIG. 6 is a block flow diagram illustrating possible funding options in accordance with the invention.

Briefly, in accordance with the invention, I provide an improved system to acquire building supplies and use the building supplies in a renovation project. The system comprises the steps of providing a transaction control system to record and monitor transactions occurring during the renovation project; providing delivery confirmation apparatus to sense and identify building material, sense a location of building material, identify a date on which building material is at the location, and generate for the transaction control system confirmation data identifying building material, the location of the building material, and the date on which building material is at the location; selecting an existing building structure for a renovation; selecting a delivery site at a selected location to receive building material for the renovation; selecting a lender of a construction loan for the renovation of the building structure; securing for the lender a first lien position on the building structure when the construction loan is less than the fair market value of the building structure; selecting a supplier of building materials; securing from the supplier for the lender the supplier's lien rights with respect to building materials delivered to the site for the renovation of the building structure; obtaining identification data for the supplier as an approved vendor; entering the identification data for the supplier in the transaction control system to create an account for the supplier; securing from the lender for the supplier an agreement for the lender for a fee to guarantee payment to the suppler within a selected contract period for building material purchased from the supplier and delivered by the supplier to the delivery site; obtaining from the lender for the renovation of the building structure a construction loan in the form of a credit line in an amount less than the fair market value of the building; purchasing with the credit line selected building material at a selected purchase price for the renovation project from the supplier for delivery within a selected time period; entering the purchase price in the transaction control system in the supplier's account; delivering the selected building material to the delivery site; utilizing the delivery confirmation apparatus to confirm the identity and location of the selected building material at the delivery site, identify the date on which the selected building material is located at the delivery site, and generate confirmation data for the transaction control system; loading the confirmation data into the transaction control system; making a payment to the supplier with funds from the lender within the selected contract period of the purchase price less a fee to the lender; entering the payment to the supplier in the transaction control system in the supplier's account; and, utilizing the selected building material for the renovation of the building structure.

Turning now to the drawings, which depict the presently preferred embodiments of the invention for the purpose of illustrating the practice thereof and not by way of limitation of the scope of the invention and in which like reference characters refer to corresponding elements throughout the several views, FIGS. 1 and 2 illustrate a system to acquire building supplies and use the building supplies in a renovation project. The first step 30 consists of acquiring an agreement between a lender and vendor(s) in a selected geographical area for the vendor(s) to receive assurance of payment by the lender within 30 days or within an agreed upon contract period in exchange for (A) a fee payable by the vendor to the lender, (B) assignment of the vendor's mechanics liens or other liens to the lender, and (C) confirmation by the lender that any building supplies purchased from the vendor(s) were delivered to a desired location. As used herein, the “lender” can be a bank, savings and loan, a trust, a separate financial account operated by company, or any other entity which lends money at interest and expects to receive payment back for the loan and the interest, either in a lump sum or in a series of payments over time. Each vendor can supply a service (i.e., architect, contractor, painter, etc.) and/or can sell tangible goods like paint, flooring, lumber, concrete, air conditioning units, etc. The fee noted above which is paid by the vendor to the lender can vary as desired, but typically is in the range of 1% to 4% of any amount paid to the vendor by the lender.

The next step 31 consists of securing a specialized transaction control or computer system (TCS) to track fund transfers and the creditworthiness of vendors. One possible embodiment of such a transaction control system is described below in more detail with respect to FIGS. 3 and 3A.

Subsequent step 32 consists of funding a master trust or other financial account via bond sales or bank loans or other investments. As is further described below, the ability to secure bonds with various liens permits a new kind of securitized bond to be sold on the bond market. The use of liens to securitize the bond permits the bond to be sold at a lower interest rate.

Step 33 consists of entering in the transaction control system (TCS) the amounts collected through bond sales, bank loans, or other investments, along with the periodic payments due on such bonds, loans, etc., with the dates the payments are due, and the name and address of to whom such periodic payments are made.

In Step 34 a loan/credit line is issued to a contractor, home owner, or other borrower at a selected interest rate for the specific designated purpose of being used for a construction project and to pay vendors involved in such a construction project. While loans may, if desired, be issued for other designated purposes, the particular currently preferred embodiment of the invention concerns loans for construction projects, and concerns, more particularly, loans to renovate existing building structures. Further, the amount of such construction loans is preferably less than the fair market value of the existing building structure; preferably less than 50% of the fair market value of the existing building structure, more preferably less than 40% of the fair market value of the existing building structure, and most preferably less than 25% of the fair market value of the existing building structure. The proceeds of the loan are designated to be used only to pay vendors involved in the particular construction project for which the loan was made. The funds associated with the loan can be dispensed in the form of cash, but it is preferred that a credit card or credit line instead be awarded so the lender will eventually pay the vendor directly, and that the credit line be utilized to purchase services or goods only from vendors designated by the lender.

Step 35 consists of purchasing supplies and/or services from a lender-designated vendor utilizing the credit line secured in step 33.

Continuing in FIG. 2, in step 36 each purchase (whether for one item or a plurality of items), lien information, and the vendor payment due date is entered in the TCS. For example, if the agreement reached with the vendor in step 30 required payment within one month, and a $200.00 purchase took place on Jun. 15, 2010, the date of the purchase, the amount of the purchase, and the vendor payment due date of Jul. 15, 2010 would be entered in the TCS. On Jul. 15, 2010, the lender would pay the vendor $200.00 on Jul. 15, 2010. The agreement reached in step 30 between the lender and vendor can also, as would be appreciated by those of skill in the art, stipulate that the vendor be paid by the lender in multiple payments.

In the event tangible building materials are purchased to be delivered to the construction site or another designated delivery site, then in step 37 delivery of the building materials is confirmed. One preferred method of confirming such delivery is for the lender to dispatch an individual to the delivery site with a hand held scanner which can scan and input UPC codes on each of the building materials to identify the type and quantity of building materials. The codes identify the material as roofing, paint, etc. In addition, each hand held scanner identifies the location of the building materials. The location can be entered in the scanner by the user, i.e., the user can type in the address of the delivery site. Or, the scanner can include a global positioning system which communicates with one or more satellites to define the location of the building materials. The scanner stores such data in memory and is configured to download in step 39 the data to the TCS via a wireless system in the scanner and the TCS, vis a print out from the scanner which is scanned into the TCS, or via any other desired data transfer system that transfers data from the scanner to the TCS. In another embodiment of the invention, a satellite senses a transmitter that is delivered with the building materials and transmits the necessary confirmation information to the TCS.

When, in step 38, timely delivery of building materials by a vendor to a desired delivery site is confirmed (or when completion of another service by a vendor is confirmed), then such confirmation is entered in step 39 in the TPC. Such data is utilized to monitor 40 the performance of the vendor. Such monitoring can be automatically programmed in the TCS, or, can be performed by an individual that reviews a printout or display of such data that has been collected by the TCS.

Evaluations of vendor performance are entered 41 in the TCS, either automatically by a program in the TCS, or by a user inputting evaluation data into the TCS.

When vendors are periodically paid according to lender—vender agreement of step 30, this is recorded 42 in the TCS.

Other payments, such as bond interest payments, payments on loans, payments to investors, etc., are also recorded in the TCS when such payments are made.

A transaction control system (TCS) which can be utilized in the practice of the invention is illustrated in FIG. 3 and includes a controller, memory, and data input 62. The controller includes control 61, and sub-routines 50 to 54. The memory includes any data 55 necessary to confirm the first lien position of the lender, data 56 defining the assignment of mechanics liens or other liens by each lender-approved vendor to the lender, data 57 confirming the timely delivery of supplies by a vendor to a designated delivery site for a designated construction project, data 58 defining orders purchased on credit from a vendor and payments made by the lender to the vendor within the time limit agreed upon in step 30. Data 59 defines the amount of loans to a homeowner, contractor, or other borrower, along with the payments due on such loan, and when such payments have been received, and whether such payments were timely made. Data 60 defines bonds that were sold, the amount of interest due on the bonds, the maturation date of the bonds, the dates on which bond payments are due bond holders, and the dates on which such payments were made. The control typically comprises a microprocessor or other computer. The memory can comprise a hard drive, CD, paper tape, or other desired storage media.

The lien security sub-routine 50 maintains a record of liens assigned by each vendor and enables the liens assigned by vendors to be displayed for viewing, printed out, or downloaded. The vendor performance sub-routine 51 maintains a record of the job performance by each vendor and enables performance data concerning each vendor to be displayed for viewing, printed out, or downloaded. The vendor account sub-routine 52 maintains a record of each purchase from a vendor, of payments made by the lender to the vendor when he purchase is by credit card or other credit instrument, and of the fee collected by the lender when the lender pays the vendor for a purchase made from the vendor. Sub-routines 52 permits such information to be called up and viewed on a display, to be printed out, or to be downloaded. Sub-routine 53 maintains a record of each loan to a borrower, of vendor credit card purchases by the borrower, of dates that payments to the lender from the borrower are due, and of payments made to the lender by the borrower. Such information can be viewed on a display, be printed out, or be downloaded onto storage media. The funding sub-routine maintains a record of bond sales to fund the lender's account 10, of loans to the lender to fund the lender's account 10, and of other investments used to fund the lender's account 10 so the lender has funds with which to make loans to home owners, the owners of commercial buildings, etc.

FIG. 3A is a block flow diagram which illustrates a typical program or logic function which is executed by the control 61 in FIG. 3. The basic control program consists of commands to “start and initialize” 70, “read memory” 72, and “transfer control” to one of sub-routines 50 to 54. Once a sub-routine receives control, it interprets 75 the memory associated with that sub-routines, performs the function(s) defined for that sub-routine, and returns 77 control to the control program. For example, the vendor account sub-routine 52 would interpret memory 58 and update vendor records as necessary (if, for example, new purchases had been made from the vendor based on credit lines issued by the lender; or, if payments had been made by the lender to the vendor in accordance with the agreement reached in step 30). The control program is repeated as indicated by the “repeat to last memory step” 73 of the control program, followed by an “end” program step 74 which completes execution of the program. As would be appreciated by those of skill in the art, any desired logic function can be developed for control 61 using well known prior art programming techniques.

FIG. 4 is another illustration of a construction loan made in accordance with one embodiment of the invention. In FIG. 4, the lender has a trust or other account 10 from which it loans money. The lender may be, but is not necessarily, a bank or savings and loan. As earlier noted, in one embodiment of the invention, the lender funds—and lends money—from a master trust or other account funded by selling bonds. The bonds are “backed” or securitized by liens. One such lien that is important in the practice of this embodiment of the invention is a lien that puts the lender in a first lien position with respect to all other lien holders—except tax liens—in connection with the building structure on which a renovation is being carried out. Being placed in a first lien position helps to securitize and reduce the interest rate payable on bonds sold in connection with such loans and also encourages lenders to make such loans. One way for the lender to be placed in such a “1^{st} lien holder” position is for other lien holders to agree to such an arrangement, preferably in writing. Another way for the lender to be placed in such a “1^{st} lien holder” position is for a legislative body, typical a state or federal legislature, to pass a law stating that a lender automatically occupies such a “1^{st} lien holder” position. It is anticipated that in the practice of this embodiment of the invention, a lender that provides a loan will achieve or be awarded a “1^{st} lien holder” position only if the loan is a construction loan to renovate an existing building structure and if the amount of the loan is less than the fair market value of the building structure, and preferably is, as earlier noted, significantly less than the fair market value of the building structure. When the amount of the renovation loan is significantly less than the fair market value of the building structure, it is more likely the loan will be paid off while at the same time improving the marketability of the building structure. In addition to the “1^{st} lien holder” position, lender can, as noted, acquire lien interests that vendors hold against the building structure in connection with the products or services that the vendors provide to complete a renovation project. Each vendor will assign some, preferably all, of such lien rights to the lender in exchange for the lender's guarantee that the vendor will be paid within a designated time after the vendor's services or products are delivered. The vendor will also possibly, as noted, pay a fee to the lender when the lender pays the vendor within the contract period agree upon in step 30.

In FIG. 4, the trust 10 makes 22 a $10,000.00 loan at 7% interest. The loan can be made to a home owner (who can be the contractor), or can be made to a contractor who is performing a renovation for a homeowner. The contractor is given a single credit card with a limit of $10,000.00, or is given two or more credit cards with limits totaling $10,000.00. The contractor 23 utilizes the credit card to purchase 24 $10,000.00 of building supplies from a lender-designated vendor 19. Vendor 19 has entered into an agreement with the lender of the type discussed with respect to step 30 in FIG. 1 and is therefore a designated vendor that contractor 23 can utilize. Vendor 19 delivers 20 the $10,000.00 in supplies to a designated delivery site. The lender confirms 21 delivery of the supplies by dispatching an individual with a scanner that reads the UPC codes on the supplies, utilizes GPS to identify to location of the supplies, and downloads this information the TCS. The lender, i.e. the trust or other account 10, pays 18 vendor 19 for the supplies within 30 days of the purchase by the contractor 23. The contractor utilizes the building supplies to carry out a renovation of the homeowner's residence. If the loan is made to the homeowner 25, the homeowner makes payments 26 to the trust 10. If the loan is made to the contractor 23, the contractor 23 makes payments to the trust.

FIG. 5 illustrates the acquisition by a lender 10 (i.e., owner of the trust or other account) of various lien interests including the 1^{st} lien position 27 and the assignment 28 by a vendor 19 of liens to the lender 10. The confirmation of delivery of supplies to a desired location 21 is, for purposes of the invention, considered to be part of acquiring a lien interest because it facilitates ensuring that money spent for supplies will actually be used to increase the value of the borrower's building structure, or of the building structure on which the borrower is working.

As used herein, a renovation comprises any work done on a building structure including, without limitation, room additions, painting, installing new appliances including air conditioning and heating equipment, water heaters, plumbing, roofing, flooring, landscaping, fencing, windows, sound systems, swimming pools, communication systems, and solar systems.

In FIG. 6, a trust or other account 10 is funded 11, by way of example and not limitation, selling 4% ABSB bonds and paying a 0.25% commission or fee for such sale. The trust 10 is also funded by obtaining a bank loan at 4% interest. The trust 10 makes periodic payments to bond holders 14 to pay interest on the bonds and eventually pay back the bond funds in full. Similarly, the trust 10 makes periodic payments to the bank 15 to repay the bank loan.

As used herein, a stop notice is one kind of lien that can be assigned by a vendor to the lender. A stop notice is a collection remedy that consists of a demand that a home owner or construction lender immediately withhold amounts out of undisbursed construction funds to satisfy a claim. A TCS can be programmed to automatically generate, track and, if needed, exercise upon certain preconditions stop notice rights on a construction project. In the same manner that each construction project has it own associated lien rights, each project may have its own associated stop notice rights.

Stop notice rights may be obtained by (1) the use of a mechanism in the TCS to assign rights from payee (borrower) to the lender, (2) utilizing a mechanism in the TCS to generate the necessary items to serve any preliminary lien notice necessary to secure and stop notice rights, (3) use of a mechanism in the TCS to internally file such stop notice rights in a database of other computer automated system so that the procedures necessary to complete a proper stop notice application can be systematically completed and exercised if warranted, (4) use of a database or other computer automated system or mechanism in a computer to identify and track and match any such stop notice rights to a specific construction project that such rights pertain to, (5) use of a database or other computer automated system or mechanism in a computer to identify and track and match any such stop notice right to a specific lender or owner of the specific construction project, (6) use of a database or other computer automated system or mechanism in a computer to identify and track and match any such stop notice rights to a specific bond or trust or other financial instrument which principal and interest and other payments it is to receive maybe or are secured by such assigned stop notice rights, liens or other security or sureties or sureties or the construction project or real or persona property of such project, and/or (7) use of a database or other computer automated system to mechanism in a computer to identify and prepare necessary notices to obtain such stop notice rights.

In an alternate embodiment of the invention, the owner of the trust or account does not provide a construction loan. A bank or mortgage company or other lending entity provides the loan. The owner of the trust or account 10 performs a service for the bank by monitoring the purchases of construction services and supplies by approved vendors and by confirming for the bank the delivery of supplies or services to the proper party or location.

Having set forth our invention in terms to enable those skilled in the art to understand and practice the invention and having set forth the presently preferred embodiments and uses thereof, I Claim:

1. A system to acquire building supplies and use the building supplies in a renovation project, comprising the steps of
(a) providing a transaction control system to record and monitor transactions occurring during the renovation project;
(b) providing delivery confirmation apparatus to
(i)sense and identify building material,
(ii) sense a location of building material,
(iii) identify a date on which building material is at the location, and
(iv) generate for the transaction control system confirmation data identifying building material, the location of the building material, and the date on which building material is at the location;
(c) selecting an existing building structure for a renovation;
(d) selecting a delivery site at a selected location to receive building material for the renovation;
(e) selecting a lender of a construction loan for the renovation of the building structure;
(f) securing for the lender a first lien position on the building structure when the construction loan is less than the fair market value of the building structure;
(g) selecting a supplier of building materials;
(h) securing from the supplier for the lender the supplier's lien rights with respect to building materials delivered to the site for the renovation of the building structure;
(i) obtaining identification data for the supplier as an approved vendor;
(j) entering the identification data for the supplier in the transaction control system to create an account for the supplier;
(k) securing from the lender for the supplier an agreement for the lender for a fee to guarantee payment to the suppler within a selected contract period for building material purchased from the supplier and delivered by the supplier to the delivery site;
(l) obtaining from the lender for the renovation of the building structure a construction loan in the form of a credit line in an amount less than the fair market value of the building;
(m) purchasing with said credit line selected building material at a selected purchase price for the renovation project from the supplier for delivery within a selected time period;
(n) entering said purchase price in the transaction control system in the supplier's account;
(o) delivering the selected building material to the delivery site;
(p) utilizing said delivery confirmation apparatus to
(i) confirm the identity and location of said selected building material at the delivery site,
(iii) identify the date on which said selected building material is located at the delivery site, and
(iii) generate confirmation data for the transaction control system;
(q) loading said confirmation data into the transaction control system;
(r) making a payment to the supplier with funds from the lender within the selected contract period of said purchase price less a fee to the lender;
(s) entering said payment to the supplier in the transaction control system in the supplier's account;
(t) utilizing said selected building material for the renovation of the building structure.
